(19) United States
(12) Patent Application Publication
(10) Pub. No.: US 2009/0280838 A1
(43) Pub. Date: Nov. 12, 2009

(54) Device and Method for Adding Location Data to Images

(76) Inventors: Ajay MALIK, Santa Clara, CA (US); Robert Perri, Bartlett, IL (US)

Correspondence Address: FAY KAPLUN & MARCIN, LLP, 150 BROADWAY, SUITE 702, NEW YORK, NY, 10038, US

(21) Appl. No.: 12/118,085

(22) Filed: May 9, 2008

(51) Int. Cl. H04Q 7/20; H04M 1/00

(52) U.S. Cl. 455/456.6; 455/556.1

(57) ABSTRACT

Described are a device and a method for adding location data to images. The method may include the following steps: capturing image data with a mobile device; creating an image file based on the image data; determining location data of the mobile device based on a location of the mobile device; and adding the location data to the image file.

### FIELD OF THE INVENTION

The present invention relates generally to a device and method for adding location data to images captured by the device. Specifically, location determining devices stamp each captured image with the location data.

### BACKGROUND

A mobile unit may be equipped with a variety of functionalities. For example, the mobile unit may be a portable phone. The portable phone may further be equipped with an image capturing device such as a camera. When capturing images with the camera, a common feature is a time stamp that indicates a date and/or a time in which the image was captured. The time stamp may be printed directly onto, for example, a corner of the image. The time stamp may aid the user of the mobile unit to recognize when the image was captured and to recall the events around the time the image was captured. However, the image may include content that is commonly found in many different places. For example, if an image was captured indoors, certain recognizable objects such as monuments may not be included. As a result, the user may not recognize a location in which the image was captured.

### SUMMARY OF THE INVENTION

The present invention relates to a device and a method for adding location data to images. The method may include the following steps: capturing image data with a mobile device; creating an image file based on the image data; determining location data of the mobile device based on a location of the mobile device; and adding the location data to the image file.

### DESCRIPTION OF THE DRAWINGS

FIG. 1 shows a mobile unit according to an exemplary embodiment of the present invention.

FIG. 2 shows a method for adding location data to images according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a mobile unit (MU) such as a cellular phone including a camera. According to the exemplary embodiments of the present invention, an image may be captured by the camera and location data may be associated therewith. The MU, the camera, the captured image, the location data, and an associated method will be discussed in further detail below.

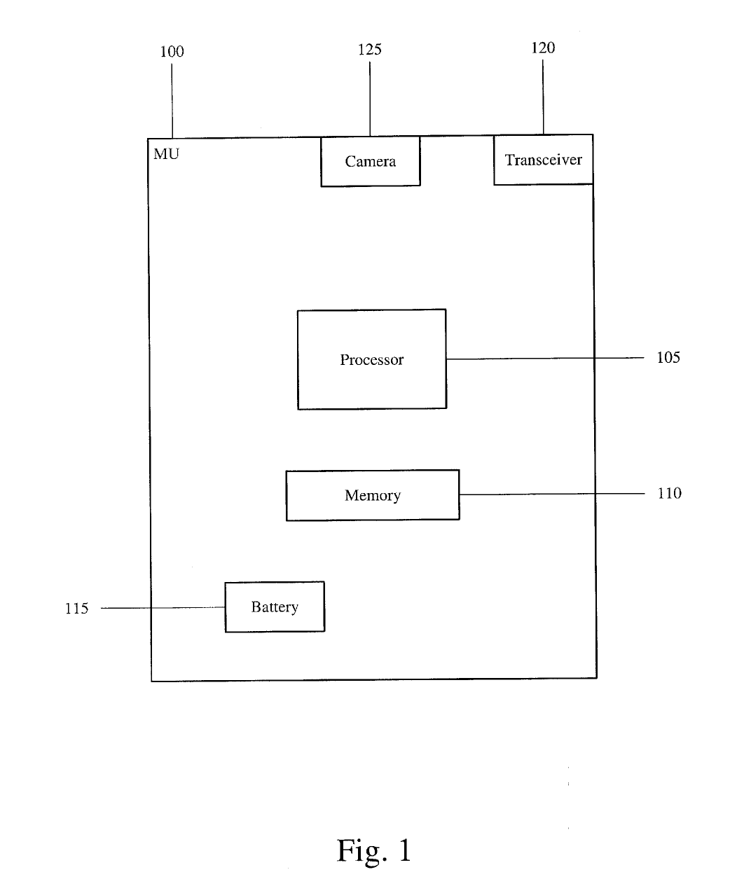

FIG. 1 shows a mobile unit (MU) 100 according to an exemplary embodiment of the present invention. The MU 100 may be any portable electronic device such as a mobile computer, a personal digital assistant (PDA), a laptop, a cell phone, a radio frequency identification reader, a scanner, an image capturing device, a pager, etc. As will be described in further detail below, the MU 100 includes an image capturing functionality and associated components. The MU 100 may include a processor 105, a memory 110, a battery 115, a transceiver 120, and a camera 125.

The processor 105 may be responsible for executing various functionalities of the MU 100. As will be explained in further detail below, according to the exemplary embodiments of the present invention, the processor 105 may be responsible for creating an image file. The image file creating functionality may be a program executed by the processor 105 that receives data from the camera 125 (directly or indirectly) and creates a corresponding image as an image file. The image file may be adjusted according to the exemplary embodiments of the present invention. Furthermore, as will be discussed in further detail below, the processor 105 may execute a location determining functionality to ascertain a location of the MU 100 at a time when an image is captured. In addition, the processor 105 may execute a communications functionality as the MU 100 is equipped with a telephone and/or other communications functionality.

The memory 110 may be a storage unit for the MU 100. Specifically, according to the exemplary embodiments of the present invention, the memory 110 may store the various programs for the image capturing functionality, the location determining functionality, and the communications functionality. The memory 110 may also store any image that is captured. The memory 110 may further store data and/or settings pertaining to various other functionalities of the MU 100. The MU 100 may include the battery 115 to supply the necessary energy to operate the MU 100. The battery 115 may be a rechargeable battery such as a nickel-cadmium battery, a lithium hydride battery, a lithium ion battery, etc. It should be noted that the term “battery” may represent any portable power supply that is capable of providing energy to the MU 100. For example, the battery 115 may also be a capacitor, a supercapacitor, etc.

The transceiver 120 may be a component enabling the MU 100 to transmit and receive wireless signals. Thus, the transceiver 120 may be an integral component for the communications functionality. Furthermore, the transceiver 120 may enable the MU 100 to associate with a wireless network such as a local area network, a wide area network, etc. The network may include a server, a database, at least one access point, a switch, a network management arrangement, etc. According to another exemplary embodiment of the present invention, the transceiver 120 may be used to transmit the captured image. The image may be received by the server and/or any other network device. The server may run the portion of the program for the image capturing functionality that adjusts the image file. The adjusted image file may be returned to the MU 100 via the transceiver 120. The adjusted image file may be stored in the memory 110.

The camera 125 may be any image capturing device. The camera 125 may be, for example, a digital camera. The camera 125 may include components such as a lens, a shutter, a light converter, etc. The images captured by the camera 125 may be stored on the memory 110. Images captured by the camera 125 may be processed by the processor 105. Images captured by the camera 125 may also be processed by a processor of the server upon transmission via the transceiver 120.

It should be noted that the processor 105 executing a portion of the image capturing functionality is only exemplary. The camera 125 may be equipped with its own processor. The camera processor may execute the image capturing functionality. A resulting image file may be forwarded to the processor 105 of the MU 100. The camera processor or the processor 105 may adjust the image file using the portion of the program responsible thereof.

In an exemplary embodiment of the present invention, the MU 100 captures an image (e.g., the combination of the camera 125 and the processor 105 capture an image and create the image file such as a .jpg file). The MU 100 may then adjust the image file to include a date and/or a time stamp. For example, the MU 100 may include an internal clock (e.g., a clock function executed by the processor 105) that records the data and/or time at which the image was captured. The date and/or time may then be superimposed onto a predetermined area of the image file (e.g., lower right corner). Those skilled in the art will understand that the superimposing of the date and/or time stamp is accomplished by adding additional data to the image file. For example, the .jpg format may store the additional date and/or time stamp data in each individual .jpg file. Thus, each .jpg file will have its own date and/or time stamp data that the user may display and/or print or turn off when displaying and/or printing, but the date and/or time stamp data remains in the .jpg file.

According to the exemplary embodiments of the present invention, a further adjustment to the image file may be a location that is superimposed onto the image file in the same manner as described above for the date and/or time stamp. The location may be determined using a location determining functionality executed by the processor 105 of the MU 100. The location determining functionality may be, for example, triangulation, received signal strength indication (RSSI), global positioning system (GPS), etc. The location may be printed on the image file in a substantially similar manner as the data and/or time is printed. For example, the location may be printed underneath the date and/or time, on a different predetermined location of the image file, etc. In another example, the location may be stored in a comments field of the image file. That is, the image file may include parametric data such as a file size, an image size, a capturing source, a date of creation, a time of creation, etc. An additional parametric datum that may be added is the location that was determined at the time the image was captured. Those skilled in the art will understand that the above exemplary embodiments were described with reference to a .jpg image file, but the present invention is not limited to this type of image file.

It should be noted that the location may not be determined at the time that the image was captured. For example, if the MU 100 is disposed in a location where a network is inaccessible (e.g., a remote location, underground, etc.), a connection to a network that includes satellites (for GPS), access points to receive the wireless signals (for RSSI), etc. may not be established. In such an example, the MU 100 may record data relating to the last location in which a connection to the network existed. The last location data may be stored on the memory 110. Thus, any image captured while the MU 100 is not connected to the network may be stamped with the last location data. Once the MU 100 re-establishes a connection to the network, the location data may be updated so that any subsequent image that is captured may be stamped with the updated location data. If the location data is not determinable, the image capturing functionality may also be equipped to receive a manual input from the user indicating the location of the MU 100.

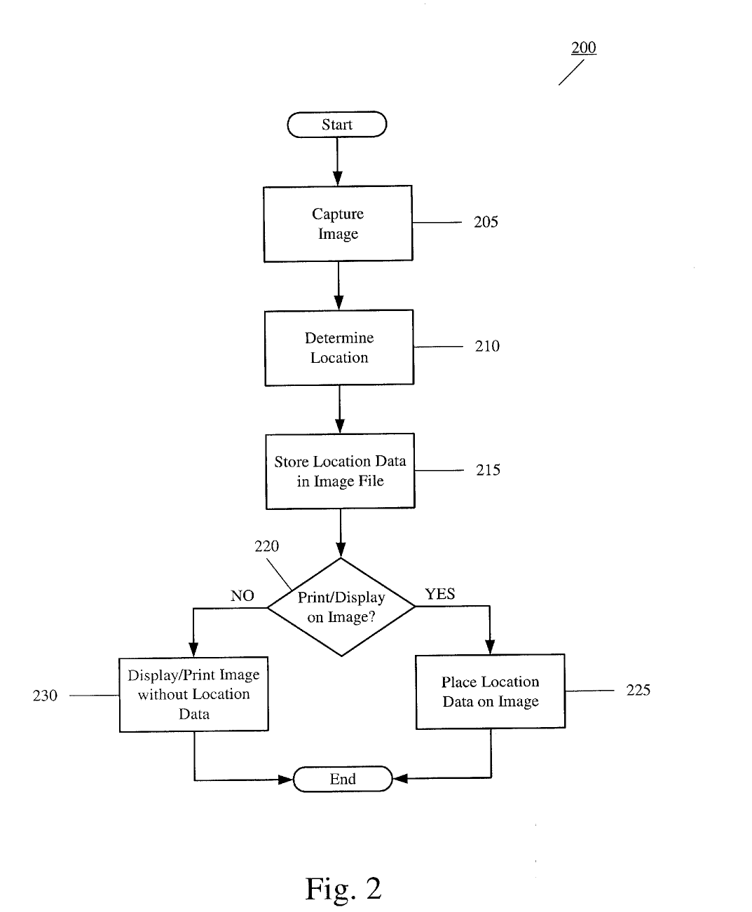

FIG. 2 shows a method 200 for adding location data to images according to an exemplary embodiment of the present invention. The method 200 may be used for the exemplary embodiments discussed above where the image capturing functionality responsible for adjusting the image file is executed by the processor 105 or the processor of the server of a network that the MU 100 is associated. The method 200 will be described with reference to the MU 100 of FIG. 1.

In step 205, an image is captured. As discussed above, the image may be captured using the camera 125 and an image file may be created using the processor 105. The image may be captured as a black and white photograph or may be captured as a color photograph. The image file may be stored on the memory 110 or may be transmitted to a database (or other storage mechanism) of a network via the transceiver 120 of the MU 100.

In step 210, a location of the MU 100 is determined. As discussed above, the MU 100 may be associated with a network via the transceiver 120. The network may be equipped with location determining components such as those used for triangulation, RSSI, GPS, etc. In such an exemplary embodiment, the network may determine the location of the MU 100 and record this information at the network and transmit the location information to the MU 100. In another exemplary embodiment, the processor 105 may execute the location determining functionality based on signals received from the network (e.g., GPS signals, communication signals, etc.) to determine the location. The location information may be stored on the memory 110 whether it is received from the network or derived by the processor 105.

The location information may be determined at a variety of times. In a first example, a continuous determination may be performed so that a constant update of the location of the MU 100 may be known. In a second example, the determination may be performed at predetermined intervals (e.g., every ten minutes, every half hour, every hour, etc.). In a third example, the determination may be performed whenever the location determining functionality indicates that a position of the MU 100 has moved a predetermined threshold distance. That is, if the MU 100 has not moved the predetermined threshold distance, the prior location that was determined is maintained while if the MU 100 has moved the predetermined threshold distance, an updated location data is determined. It should be noted that the location determination may be performed at preset times. In a first example, the location may be determined upon the MU 100 being activated. In a second example, the location may be determined each time the MU 100 successfully associates with the network. In a third example, the location may be determined whenever an image is captured.

In step 215, the location data is stored in the image file (e.g., in a comments field). In a first exemplary embodiment, the image capturing functionality may retrieve the location data that was determined in step 210 and create an additional parameter in the comments field where the location data is entered. In a second exemplary embodiment, the image capturing functionality may create the image file with an open parameter in which the location data is to be entered. Thus, upon determining the location of the MU 100, the location data is entered into the open parameter.

In step 220, a determination is made whether location data is to be printed and/or displayed with the image file. As discussed above, the location data may be printed onto the image file or may be stored as an additional parameter in a comments field of the image file. In a first exemplary embodiment, the determination may be made through a prompt given to the user. The prompt may ask the user if the location data is to be printed and/or displayed on the image when it is output. Through a user interface (e.g., keypad, touch screen display, etc.), the user may indicate to the image capturing functionality the placement of the location data. In a second exemplary embodiment, the determination may be performed as a preliminary step made prior to capturing the image. For example, if the camera 125 is activated, an initial step may be to ask the user where the location data is to be placed for each image that is captured. In another example, settings for the image capturing functionality may be set by the user. One of the settings may be the placement of the location data. The settings may also enable the user to deactivate the placement of the location data.

If the location data is to be printed and/or displayed on the image file, the method 200 continues to step 225. Another prompt may be given to ask where on the image file the location data is to be printed. For example, the prompt may have a scroll down input field with four options (e.g., upper right corner, upper left corner, lower right corner, and lower left corner). The placement of the location data on the image file may also be determined through the settings. That is, the user may set the placement setting to a specific predetermined location (e.g., underneath a date and/or time stamp). Those skilled in the art will understand that the user may switch the preference for displaying and/or printing at any time. If the location data is not to be printed and/or displayed on the image file, the method 200 continues to step 230 where the image is printed and/or displayed with only the image.

It should be noted that the method 200 may include additional steps. For example, between steps 205 and 210, a determination may be made whether the MU 100 is associated with the network. The determination may also be made whether the location determining components of the network are operating when the MU 100 is associated with the network. Thus, if the location is determinable, then the method 200 continues to step 210. If the location is not determinable, then the method 200 may include a subsequent step where a prior location data is used for any stamping of an image with location data. If the location is not determinable, the method 200 may include yet another step where the user may manually enter the location. In another example, between steps 215 and 220, a prompting step may be included where the user is asked if the location data is to be stamped onto the image file.

It should be noted that the exemplary embodiments of the present invention may be used with pre-existing components of the MU 100. In another embodiment, additional components may be added to the MU 100 to perform the location stamping onto the image files. The image capturing functionality may be a software update for the components involved with the location stamping. It should also be noted that the components involved with the location stamping may be included as a module. That is, the location stamping module may be coupled to cameras that are not equipped with location stamping. The location stamping module may include, in relevant part, the processor 105 and the transceiver 120.

The exemplary embodiments of the present invention may be used for a variety of purposes. For example, the location data may be used for personal use. A user may not readily recognize where an image was captured (e.g., image was taken too long ago that the memory of the image is not recognized). The location data may jog the user's memory of the place that the image was captured. In another example, the location data may be used for law enforcement agencies. If an image of a criminal at large was captured by a street camera, the location data may already be available. However, if the image was captured using a mobile camera, the location may not be available. The stamping of the location data may assist the law enforcement agency to readily identify where the image was taken so that a narrow search area may be determined based on the location data associated with the captured image. In yet another example, the location data may be used for searching and organization purposes. Many images that include the location data may be stored on the memory 110. The processor 105 may be configured to enable a search of the images. The user may specify to search only images where the location data is specified according to an input from the user. The processor 105 may also be configured to organize files (e.g., alphabetical, by file type, etc.). An additional form of organizing the files may be through the location data.

Those skilled in the art will understand that the above described exemplary embodiments may be implemented in any number of manners, including, as a separate software module, as a combination of hardware and software, etc. For example, the recognition application may be a program containing lines of code that, when compiled, may be executed on the processor 105.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
an image capturing component capturing image data; and
a processor creating an image file based on the image data, the processor further placing location data in the image file based on a location of the mobile device.

2. The mobile device of claim 1, wherein the processor determines the location data.

3. The mobile device of claim 1, further comprising:
a transceiver receiving the location data and forwarding the location data to the processor.

4. The mobile device of claim 1, wherein the location data is one of a previously determined location of the mobile device prior to the image data being captured and a current location where the image data is captured.

5. The mobile device of claim 1, wherein the location data is stored in a comments field of the image file.

6. The mobile device of claim 1, wherein the location data is superimposed onto one of a printout and a display of the image file.

7. The mobile device of claim 5, wherein the comments field further includes at least one of an image file size, an image size, an identity of the camera, a time of the capturing, and a date of the capturing.

8. The mobile device of claim 7, wherein at least one of the time of the capturing and the date of the capturing is further superimposed onto one of a display and a printout of the image file.

9. The mobile device of claim 1, wherein the location data is determined using at least one of a triangulation, a received signal strength indication (RSSI), and a global positioning system (GPS).

10. A method, comprising:
capturing image data with a mobile device;
creating an image file based on the image data;
determining location data of the mobile device based on a location of the mobile device; and
adding the location data to the image file.

11. The method of claim 10, wherein a processor of the mobile device determines the location data.

12. The method of claim 10, further comprising:
receiving the location data.

13. The method of claim 10, wherein the location data is one of a previously determined location of the mobile device prior to the image data being captured and a current location when the image data is captured.

14. The method of claim 10, further comprising:
storing the location data in a comments field of the image file.

15. The method of claim 14, further comprising:
superimposing the location data onto one of a display and a printout of the image file.

16. The method of claim 14, wherein the comments field further includes at least one of an image file size, an image size, an identity of the mobile device, a time of the capturing, and a date of the capturing.

17. The method of claim 16, further comprising:
further superimposing at least one of the time of the capturing and the date of the capturing onto one of a display and a printout of the image file.

18. The method of claim 10, wherein the location data is determines using at least one of a triangulation, an RSSI, and a GPS.

19. A computer readable storage medium including a set of instructions executable by a processor, the set of instructions operable to:
capture image data with a mobile device;
create an image file based on the image data;
determine location data of the mobile device based on a location of the mobile device; and
add the location data in the image file.
